(19) United States
(12) Patent Application Publication
(10) Pub. No.: US 2026/0302404 A1
(43) Pub. Date: Oct. 1, 2026

(54) A BATTERY BOX OF A VEHICLE

(71) Applicant: AUTOTECH ENGINEERING S.L., Amorebieta-Etxano (Vizcaya) (ES)

(72) Inventors: Iker VALENCIANO MARTIN, Mungia, Vizcaya (ES); Maria Isabel BLANCO GONZALEZ, Vigo, Pontevedra (ES); Iñigo TERREROS GALINDEZ, Laudio-Llodio, Álava (ES); Aitor UZABAL DEL BUEY, Portugalete, Vizcaya (ES)

(21) Appl. No.: 19/489,877

(22) PCT Filed: Jun. 5, 2024
(86) PCT No.: PCT/EP2024/065451

§ 371 Date: Dec. 3, 2025

(30) Foreign Application Priority Data
Jun. 6, 2023 (EP) 23382543.9

(51) Int. Cl. H01M 10/625; B60L 50/64; B60R 16/033; H01M 10/613; H01M 10/6568; H01M 50/204; H01M 50/224; H01M 50/227; H01M 50/231; H01M 50/249; H01M 50/271

(52) U.S. Cl. CPC H01M 10/625; B60L 50/64; B60R 16/033; H01M 10/613; H01M 10/6568; H01M 50/204; H01M 50/224; H01M 50/227; H01M 50/231; H01M 50/249; H01M 50/271; H01M 2220/20

(57) ABSTRACT

The present disclosure relates to a battery box of a vehicle comprising an enclosure for holding one or more battery cells, wherein the enclosure is formed between a base wall, a cover wall and one or more sidewalls. The base wall and/or the cover wall are formed by a first layer of metal. The battery box further comprises a second layer of a polymeric material. The first layer is joined to the second layer and cooling channels are formed between the first layer and the second layer.

The present application claims the benefit of EP 23382543.9 filed on Jun. 6, 2023.

The present disclosure relates to battery boxes of vehicles, and more particularly relates to battery boxes of vehicles comprising cooling channels.

### BACKGROUND

Traction batteries are an essential part of electric and hybrid vehicles which provide power to an electric motor of the vehicle. The electronic and chemical nature of these batteries makes them particularly sensitive to high mechanical loads, e.g. crash impacts.

In order to ensure safety of passengers, and avoid malfunction, one of the challenges of the automotive industry is the protection of traction batteries in case of a collision.

Vehicles such as cars incorporate a structural skeleton designed to withstand and ab-sorb impacts in case of e.g. collisions with other cars, obstacles or pedestrians. The structural skeleton of a car in this sense may include e.g. bumpers, pillars (A-pillar, B-pillar, C-pillar, D-pillar), side impact beams, rockers or sills, hinge pillars and shock absorbers.

In vehicles, traction batteries are generally placed inside a battery box, which is generally mounted in the lower area of the vehicle under a passenger cabin. In a crash event, the structural skeleton of the vehicle absorbs most of the impact energy but part of that energy may still be transmitted to the battery box.

To extend battery lifespan and protect them against external collisions, the automotive industry has put considerable effort into providing battery enclosures and load bearing structures suitable for electrically powered vehicles. Thus, a wide range of protection elements has been designed and engineered during the last years to accommodate and protect traction batteries.

The battery box may be made of materials which have high stiffness and strength and low weight. Steel battery boxes or battery trays as well as battery boxes made of polymeric (plastic) or composite components have been designed in order to improve battery protection in case of collisions.

During operation, batteries generate heat which leads to an increase of their internal temperature. Additionally, batteries may experience unsafe low temperatures during the winter months in some regions. In order to avoid reduction of the batteries life span, it is a common practice to arrange thermal management systems within the battery boxes to either absorb or to bring heat, thus allowing for a safe functioning of the batteries. Furthermore, batteries may also need to be heated prior to fast charging procedures. Thermal management systems typically comprise cooling fluids or heat transfer fluids which flow through channels arranged in the battery box.

Battery boxes comprising metallic thermal management systems, which are well-known for their thermal conductivity e.g. aluminium cooling plates, tend to increase the total weight of the vehicle. On the other hand, non-metallic thermal management systems, such as cooling systems comprising polymeric materials, can have a reduced efficiency due to their low thermal conductivity. Nevertheless, they can integrate sub-components such as cooling connections in their manufacturing process (e. g injection moulding).

It is a challenge to efficiently regulate the temperature of the batteries comprised in a battery box of a vehicle without significantly increasing the total weight of the vehicle, and without significantly increasing the complexity of the thermal management systems themselves, and without reducing impact resistance of the battery box.

### SUMMARY

In a first aspect, a battery box of a vehicle is provided. The battery box comprises an enclosure for holding one or more battery cells. The enclosure is formed by a base wall, a cover wall and one or more sidewalls. The base wall and/or the cover wall are formed by a first layer of metal. The battery box comprises a second layer of a polymeric material. The first layer is joined to the second layer. Cooling channels are formed between the first layer and the second layer.

A battery box with cooling channels formed between a first layer of metal and a second layer of a polymeric material enables efficient thermal management of the battery cells with reduced weight and complexity of the battery box. In addition, good rigidity of the battery box in order to protect the integrity of the battery cells in an impact may still be provided, thus potentially removing the need for additional undercover parts. The battery box may be able to regulate the temperature of the batteries while ensuring that there is no contact between the cooling liquid and the battery cells.

Even though reference is made to “cooling channels”, which are described to convey a cooling fluid, it should be clear that depending on the needs, the same fluid may be used to heat the battery box. The fluid may also be described as heat transfer fluid. Cooling channels may thus herein be regarded as channels, tubes or other conduits that are configured to transfer a heat transfer fluid, either for cooling or for heating.

In some examples, the first layer may be substantially flat and the second layer may comprise one or more recesses or undulations. In some examples, the first layer may be made of aluminium.

In some examples, the base wall and/or the cover wall may be formed by a substantially flat metal sheet. In some examples the battery box may comprise a battery tray for receiving the battery cells, and the flat metal sheet may be joined to sidewalls of the battery tray.

In some examples, the sidewalls of the battery box may be made from extruded aluminium profiles. A battery box with sidewalls which are highly resistant to impact loads may thus be provided.

Throughout the present disclosure, a battery tray may be regarded as a receptacle suitable for receiving the battery cells. A battery tray may comprise a bottom and sidewalls.

In some examples, the battery box may comprise a battery tray, and the sidewalls of the battery tray may be made from a different material than the flat metal sheet. The sidewalls of the battery tray may be made from steel, and the flat metal sheet may be made from aluminium in an example.

In some examples, the battery box may comprise a battery tray for receiving the battery cells, wherein the battery tray is formed by deforming a metal blank, and wherein the battery tray includes the first layer of metal. In some examples, deforming the metal blank may comprise hot stamping the metal blank. Hot stamping is a well-known technology for providing components with high strength and a suitable shape. In other examples, cold metal stamping may also be an option if there is no need for such high strength protection.

### BRIEF DESCRIPTION OF THE DRAWINGS

Non-limiting examples of the present disclosure will be described in the following, with reference to the appended figures, in which:

FIG. 1 shows a cross sectional view of an example of a battery box of a vehicle;

FIG. 2 shows a cross sectional view of a further example of a battery box of a vehicle;

FIG. 3 shows a cross sectional a view of another example of a battery box of a vehicle;

FIG. 4a shows a top perspective view of a first layer of metal and a second layer of a polymeric material before being joined;

FIG. 4b shows a top perspective view of a cover of a battery box comprising the layers of FIG. 4a;

The figures refer to example implementations and may only be used as an aid for understanding the claimed subject matter, not for limiting it in any sense.

### DETAILED DESCRIPTION OF EXAMPLES

In these figures, the same reference signs have been used in different figures to designate matching elements.

FIG. 1 schematically illustrates a cross sectional view of a battery box 100 of a vehicle according to an example of the present disclosure. In the example of FIG. 1, the vehicle may be an electric vehicle. The battery box 100 may be mounted on a lower area of the vehicle.

The battery box 100 comprises an enclosure 110 for holding one or more battery cells 200. The enclosure 110 is formed between a base wall 111, a cover wall 112 and one or more sidewalls 113. The base wall 111 and/or the cover wall 112 are formed by a first layer 120 of metal. The battery box 100 comprises a second layer 130 of a polymeric material. The first layer 120 is joined to the second 130 layer and cooling channels 140 are formed between the first layer 120 and the second layer 130.

Cooling channels are not fully defined within a metal or within a polymeric material structure. A part of the cooling channels is defined by a metal and the other part of the cooling channels may be defined by a polymer. The inside surface of the cover and/or the base, i.e. the surface that faces the inside of the battery box and the battery cells, is made of a metal which may be selected for its heat conductivity.

Cooling fluid may flow through cooling channels and temperature regulation of the battery cells in the battery box may be achieved, with a good conductivity in the cell side and good insulation to the outside, while providing a battery box with reduced weight and complexity and which may protect the battery cells against external impacts. The battery box may comprise reduced weight compared with the battery boxes comprising metal cooling channels and better heat conductivity than battery boxes comprising polymeric cooling channels. A lighter battery box with improved thermal efficiency may be provided.

As shown in FIG. 1, the first layer 120 may be substantially flat and the second layer 130 may comprise one or more recesses or undulations. Cooling channels 140 are formed by the space between the joined first and second layers 120, 130 and particularly in the space created by the recesses or undulations.

In some examples, the size and shape of the recesses or the undulations may be substantially constant. The recesses may e.g. have constant pitch and/or constant depth and/or constant width. In other examples, size and shape of the recesses may be varied. Suitable cooling channels may be provided based on the cooling needs. The cooling channels 140 formed between the first and second layer 120, 130 may be connected between them forming a single path for a cooling fluid, which may flow through the cooling channels.

The first layer may be made of aluminium. The aluminium of the first layer may be an aluminium alloy selected from the groups 3000, 5000, 6000 and 7000 series aluminium alloys. These series are characterized by their strength, corrosion resistance and weldability. Also, aluminium has very good heat conductivity. Heat transfer between a cooling fluid in the cooling channels and the battery cells comprised in the battery box through the aluminium may lead to improved temperature regulation of the battery cells.

In other examples, the first layer may be made of steel. Depending on the needs, the heat transfer achieved by a thin steel plate may be sufficient.

In some examples, the first and second layers 120, 130 may be joined by an adhesive. In other examples the first and second layers 120, 130 may be joined by mechanical joining. In further examples, the first and second layers 120, 130 may be joined by both an adhesive (or sealant) and by mechanical joining.

In other examples, the first and second layers 120, 130 may be joined by any other suitable means which may ensure that the first and second layers are accurately joined and that a cooling fluid only flows through the recesses or undulations of the polymeric material and does not exit the cooling channels formed between the first and second layer. The second layer 130 may be joined to the first layer 120 in areas between the recesses or undulations.

The base wall 111 and/or the cover wall 112 may be formed by a substantially flat metal sheet. The flat metal sheet may comprise a homogeneous thickness 0.5-4.0 mm, more specifically 1.0-3.0 mm. Joining the first and second layers may be easier and increased contact surface between the first layer and the battery cells may be achieved, leading to an enhanced heat exchange between a cooling fluid and the battery cells.

In the example shown in FIG. 1, both the base wall 111 and cover wall 112 of the enclosure may be formed by a substantially flat metal sheet joined to a layer of polymeric material forming cooling channels 140 between them. Cooling fluid may flow through the upper cover and the undercover of the battery box, providing an improved cooling of the battery cells.

The battery box 100 comprises metallic sidewalls 113. Metallic sidewalls may provide a battery box with improved impact resistance. In some examples, the one or more sidewalls 113 may be made of aluminium or steel.

The battery box 100 may therefore comprise a metallic enclosure 110 for holding one or more battery cells 200 formed by one or more metallic sidewalls 113 and a base wall 111 and/or a cover wall 112 formed by a first layer 120 of metal. The battery box 100 may further comprise a second layer 130 of a polymeric material joined to the first layer 120 of metal forming the base wall 111 and/or the cover wall 112 of the enclosure, such that the upper cover and/or the undercover of the battery box comprise a polymeric material. A battery box having cooling means, an improved impact resistance and a reduced weight may be provided.

As shown in FIG. 1, the sidewalls 113 of the battery box may be made of extruded aluminium profiles. The extruded aluminium profiles may be joined to the base wall 111 and cover wall 112 of the battery box and may provide an enclosure with sidewalls which are highly resistant to impact loads with good manufacturability. Better protection of the battery cells in the battery box in a collision may be provided.

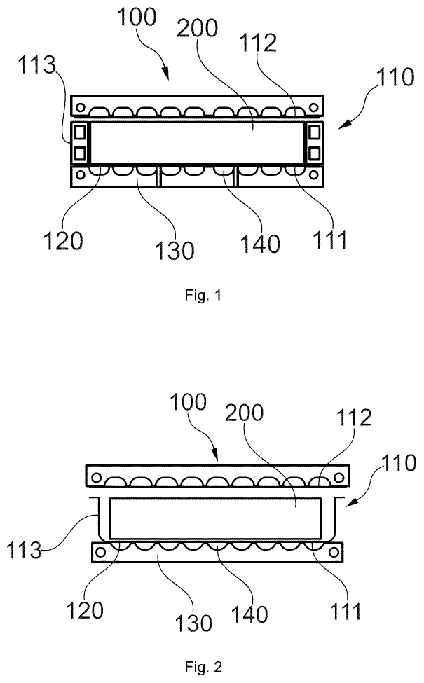

FIG. 2 shows a cross sectional view along a transverse or lateral direction, i.e. along a line that is perpendicular to a longitudinal direction of another example of a battery box 100 of a vehicle according to the present disclosure. In the example shown in FIG. 2, the enclosure of the battery box 100 may comprise a battery tray for receiving the battery cells 200.

Throughout the present disclosure, a battery tray may be regarded as a receiving receptacle for the battery cells. The battery tray may comprise a bottom 111 and sidewalls 113. The battery tray may be made of e.g. steel.

In some examples, the battery box 100 may comprise a battery tray for receiving the battery cells, and the flat metal sheet forming the base wall 111 of the battery box may be the base of the battery tray.

Battery cells 200 may be held in the battery tray, and the base of the battery tray may be joined to a layer of polymeric material such that cooling channels 140 are formed between them. Cooling fluid flowing through the cooling channels 140 may directly contact the battery tray, reducing the temperature of the battery cells held on it in a highly efficient manner.

The flat metal sheet comprising the base 111 of the battery tray may be joined to the sidewalls 113 of the battery tray e.g. by welding.

Further, the battery tray may be made of different materials. In some examples, the sidewalls 113 of the battery tray may be made from a different material than the material of the flat metal sheet comprising its base 111. Having a battery tray with different material in the sidewalls may allow to design sidewalls which may withstand high loads caused by an impact. A battery box having improved impact resistance and cooling means with reduced weight may be provided.

In some examples, the sidewalls of the battery tray may be made of steel, specifically hot stamped steel and the flat metal sheet comprising the base of the battery tray may be made from aluminium.

In some examples, for the sidewalls of the battery tray, martensitic or ultra high strength steels may be used. Improved thermal management of the battery cells may be achieved while providing a battery box with reduced weight and strong and resistant sidewalls. The battery cells may be more protected in case of a collision.

An ultra high strength steel may herein be regarded as a steel having an ultimate tensile strength of at least 1.000 MPa, and optionally at least 1.500 MPa. An ultra high strength may obtain such ultimate tensile strength after a suitable heat treatment. In particular, an ultimate tensile strength may obtain a martensitic microstructure after a suitable heat treatment. Boron steels like 22MnB5 or 37MnB5 are two examples of suitable steels. In other examples, a martensitic cold forming steel might be used, e.g. MS 1200.

Usibor® 1500P is an example of a 22MnB5 steel. The composition of Usibor® 1500 P is summarized below in weight percentages (rest is iron (Fe) and impurities):
Maximum carbon (C) (%): 0.25
Maximum silicon (Si) (%): 0.4
Maximum manganese (Mn) (%): 1.4
Maximum phosphorus (P) (%): 0.03
Maximum sulphur(S) (%): 0.01
Aluminium (Al) (%): 0.01-0.1
Maximum titanium (Ti) (%): 0.05
Maximum niobium (Nb) (%): 0.01
Maximum copper (Cu) (%): 0.20
Maximum boron (B) (%): 0.005
Maximum chromium (Cr) (%): 0.35

Usibor® may have a yield strength of e.g. 1.100 MPa, and an ultimate tensile strength of 1.500 MPa.

As shown in FIGS. 1 and 2, the battery box 100 may comprise a cover including the thermal management system formed by a first layer of metal and a second layer of a polymeric material.

In some examples, the battery box may comprise a cover including the cover wall 112 of the enclosure and an outer side. In some examples, the cover wall 112 may be made from aluminium and the outer side of the cover may be formed by a second layer of polymeric material such that cooling channels are formed between the cover wall made of aluminium and the second layer.

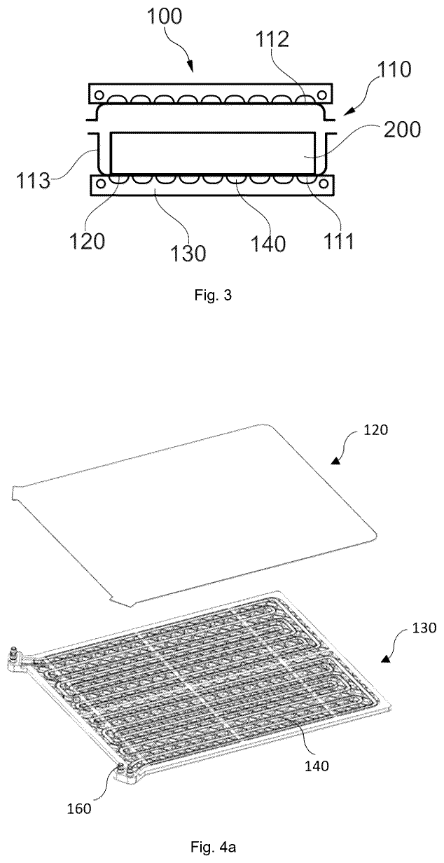

FIG. 3 shows a further example of a battery box 100 of a vehicle comprising a battery tray according to the present disclosure. As shown in this figure, the battery tray may be formed by deforming a metal blank and the first layer of metal may be included in the battery tray.

The battery tray may comprise a bottom and sidewalls which may be formed by deforming a single metal blank. In some examples, the metal blank may be made of aluminium e.g. an aluminium alloy selected from the groups 3000, 5000, 6000 and 7000 series aluminium alloys. In other examples, the metal blank may be made of a steel e.g. an ultra high strength steel such as boron steel. In addition, the first layer of metal forming the base wall 111 of the battery box may comprise the bottom of the battery tray. Further, the bottom of the battery tray may be joined to a polymeric material such that cooling channels are formed between them.

In some examples, deforming the metal blank may comprise hot stamping the metal blank. Hot stamping may involve heating a blank to a suitable temperature, particularly to above an austenization temperature, and more particularly to above an Ac3 temperature. After suitable austenization, the blanks may be positioned in a press in which they are deformed to give them their final shape, and in which they are rapidly cooled (quenched, particularly at a rate that is higher than their critical cooling rate) to obtain a martensitic microstructure.

In other examples, depending on the strength and stiffness requirements, deforming the metal blank may comprise cold stamping the metal blank. For example, martensitic steel blanks may be used. Cold stamping may involve obtaining a desired final shape of the blank by deforming non-heated metal blanks in a press.

The battery box 100 shown in FIG. 3 may comprise a cover including a second layer 130 of a polymeric material and a cover wall formed by a first layer 120 of metal. As shown in FIG. 3, the cover wall of the battery box may also be formed by deforming a metal blank. The cover of the battery box may therefore be formed by joining a deformed metal blank to a polymeric material, such that cooling channels are formed between the metal blank and the polymeric material.

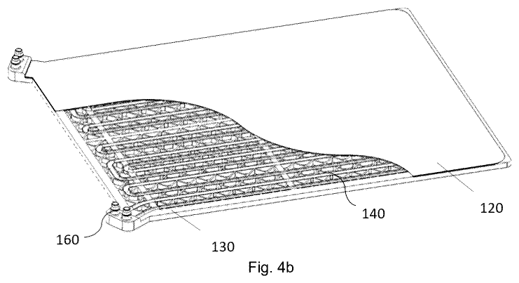

As schematically shown in FIGS. 1, 2 and 3, a fluid supply connector and/or a fluid outlet connector 160 may be integrally formed with the second layer 130 of a polymeric material. The fluid supply connector may supply fluid to the cooling channels 140 (see FIGS. 4a and 4b). Cold fluid may enter the cooling channels 140 through the fluid supply connector. The fluid may warm up while flowing through the cooling channels 140, exchanging heat with the first layer 120 of metal and dissipating heat of the battery cells. Warm fluid may exit the cooling channels through the fluid outlet connector.

Further, the second layer 130 may be formed by injection moulding. Recesses or undulations in the second layer may be easily formed. The number of assembly steps may be reduced.

FIG. 4a shows a perspective view of a first layer 120 of metal and a second layer 130 of a polymeric material of a cover of a battery box. FIG. 4a shows the first and second layers 120, 130 before being joined to each other. The cover may be an undercover (i.e. facing the road underneath the vehicle) of a battery box or an upper cover (i.e. facing upwards towards the inside of the vehicle) of a battery box.

In some examples, the battery box 100 may comprise an undercover with cooling channels 140 formed between a first layer 120 of metal and a second layer 130 of polymeric material. In other examples, the battery box 100 may comprise an upper cover with cooling channels 140 formed between a first layer 120 of metal and a second layer 130 of polymeric material.

As shown in FIG. 4a, the first layer 120 of metal may be substantially flat and may have a substantially squared shape. A first side of the first layer 120 may be in contact with a cooling fluid and an opposite side of the first layer 102 may be part of the base wall 111 or cover wall 112 of the battery box or may be in contact with them. The fist layer 120 of metal may have a thickness of e.g. 0.5-4.0 mm, more specifically 1.0-3.0 mm, and may enable heat transfer between the battery cells and the cooling fluid. In some examples, the first layer may be made of aluminium.

The second layer 130 of polymeric material may be an outer side of the cover and of the battery box. The second layer 130 of polymeric material may comprise one or more recesses or undulations which may extend along a longitudinal direction of the second layer 130, such that cooling channels 140 may be formed from side to side of the second layer. The recesses or undulations may extend twisting and turning in a serpentine path, comprising e.g. several S-shaped turns. In addition, the shape and size of the first layer 120 may be substantially the same as the shape and size of the second layer 130, such that the one or more recesses or undulations of the second layer of polymeric material are covered by the first layer 130 of metal and the cooling channels 140 formed between the first and second layer 120, 130 are sealed (shown in FIG. 4b). Cooling or heat transfer fluid may flow through the sealed cooling channels 140 absorbing heat energy from the first layer 120 of metal or delivering heat energy towards it.

Further, the second layer 130 of polymeric material may comprise a lattice structure between the undulations or recesses and an opposite outer side of the layer. Energy absorption of the second layer in case of an impact may be enhanced and less impact load may reach the battery cells held in the battery box. Also, a lattice structure may provide reduced weight of the cover as compared to a cover with a full solid structure. The total weight of the battery box may be decreased.

In the example shown in FIG. 4a, the undulations or recesses of the second layer which form the cooling channels are placed throughout the whole area of the second layer such that a cooling fluid flowing through the cooling channels may be distributed substantially through the entire area of the first layer of metal. In other examples, the second layer 130 may comprise areas or sections without undulations or cooling channels, such that only a certain area of the cover of the battery box is cooled through the cooling system. Injection moulding of a layer of polymeric material comprising sections without undulations may be simplified.

In other examples, the battery box may comprise different modules (FIG. 1), which may be put together to define a cover of the battery box. In some examples at least one of the different modules may comprise a first layer of metal joined to a second layer of polymeric material such that cooling channels are formed between the two layers. In addition, each of the different modules may comprise fluid connectors. In some examples a cover of the battery box may comprise a first module and a second module. The modules may be joined to each other. In case of damage of a certain module, only the damaged module may be replaced.

FIG. 4b shows a top perspective view of a cover of a battery box comprising the first layer 120 and second layer 130 shown in FIG. 4a.

Although only a number of examples have been disclosed herein, other alternatives, modifications, uses and/or equivalents thereof are possible. Furthermore, all possible combinations of the described examples are also covered. Thus, the scope of the present disclosure should not be limited by particular examples, but should be determined only by a fair reading of the claims that follow.

1. A battery box (100) of a vehicle comprising an enclosure (110) for holding one or more battery cells (200), wherein the enclosure (110) is formed by a base wall (111), a cover wall (112) and one or more sidewalls (113), the sidewalls (113) made of aluminium or steel, wherein
the base wall (111) and/or the cover wall (112) are formed by a substantially flat first layer (120) of metal, and
the battery box (100) comprises a second layer (130) of a polymeric material and which comprises one or more recesses or undulations, wherein
the first layer (120) is joined to the second layer (130), and wherein cooling channels (140) are formed between the first layer (120) and the second layer (130).

2. The battery box (100) according to claim 1, wherein the first layer (120) is made of aluminium.

3. The battery box (100) according to claims 1 or 2, wherein the first and second layers (120, 130) are joined by adhesive and/or mechanical joining.

4. The battery box (100) according to any of claims 1-3, wherein the base wall (111) and/or the cover wall (112) is formed by a substantially flat metal sheet.

5. The battery box (100) according to claim 4, wherein the battery box (100) comprises a battery tray for receiving the battery cells (200), wherein the flat metal sheet is a bottom of the battery tray, and wherein the flat metal sheet is joined to sidewalls (113) of the battery tray.

6. The battery box (100) according to claim 5, wherein the sidewalls (113) of the battery tray are made from a different material than the flat metal sheet.

7. The battery box (100) according to claim 6, wherein the sidewalls (100) are made from steel, and the flat metal sheet is made from aluminium.

8. The battery box (100) according to claim 4, wherein the sidewalls (113) are made of extruded aluminium profiles.

9. The battery box (100) according to any of claims 1-3, wherein the battery box (100) comprises a battery tray for receiving the battery cells (200), and wherein the battery tray is formed by deforming a metal blank, and wherein the battery tray includes the first layer (120) of metal.

10. The battery box (100) according to claim 9, wherein deforming the metal blank comprises hot stamping the metal blank.

11. The battery box (100) according to any of claims 1-10, wherein a fluid supply connector and/or a fluid outlet connector (160) is integrally formed with the second layer (130).

12. The battery box (100) according to any of claims 1-11, wherein the second layer (130) is formed by injection moulding.

13. The battery box (100) according to any of claims 1-12, comprising a cover, wherein the cover includes the cover wall made of aluminium and an outer side formed by the second layer (130).
